(19) United States
(12) Patent Application Publication
(10) Pub. No.: US 2008/0264994 A1
(43) Pub. Date: Oct. 30, 2008

(54) Apparatus, system, and method for scoring a moving glass ribbon

(76) Inventors: Patrick Jean Pierre Herve, Avon (FR); Douglas Edward McElheny, Lancaster, KY (US)

Correspondence Address: CORNING INCORPORATED, SP-TI-3-1, CORNING, NY, 14831, US

(21) Appl. No.: 12/150,545

(22) Filed: Apr. 29, 2008

Related U.S. Application Data
(60) Provisional application No. 60/926,964, filed on Apr. 30, 2007.

(51) Int. Cl. C03B 33/033

(52) U.S. Cl. 225/2; 225/96

(57) ABSTRACT

An apparatus for scoring a glass ribbon moving along a longitudinal axis of a channel includes a linear slide adapted for mounting across the channel at an angle relative to a transverse axis of the channel, a traveling carriage coupled to the linear slide for travel along the linear slide, and a light-emitting device coupled to the traveling carriage and operable to emit a light beam at a wavelength that is absorbable at a surface of the glass ribbon.

### CROSS-REFERENCE TO RELATED APPLICATION

This application claims the benefit of priority under U.S.C. §119(e) of U.S. Provisional Application No. 60/926,964 filed on Apr. 30, 2007.

### TECHNICAL FIELD

The invention relates generally to methods and apparatus for scoring and severing a moving glass ribbon.

### BACKGROUND

A traveling anvil machine (TAM) is used in forming a horizontal score line on a moving glass ribbon. The TAM travels in the same direction as the glass ribbon at a speed that matches the speed of the glass ribbon. While traveling in the same direction as the glass ribbon, a linear slide mounted on the TAM traverses perpendicularly the direction of the TAM and therefore the travel direction of the glass ribbon. As the TAM moves with the glass ribbon, a scoring wheel attached to the linear slide makes contact with and scores the glass ribbon, creating a horizontal score line across the glass ribbon. The score line makes it easier to sever a glass piece from the glass ribbon using conventional bending techniques. In the case of a fusion draw process where the surfaces of the moving glass ribbon are unsupported, it is necessary to provide a reaction force against the action of the scoring wheel while scoring the glass ribbon. Typically, a horizontal nose is applied against the backside of the glass ribbon, in opposing relation to the scoring wheel, to provide the necessary reaction force. The horizontal nose typically has to be coupled to the TAM so that its position on the glass ribbon can be synchronized with the position of the score line.

As can be appreciated, scoring using the TAM is a complex process and requires hard contact with the surfaces of the glass ribbon. A less complex but effective scoring system for a moving glass ribbon could be beneficial.

### SUMMARY

In one aspect, the invention relates to an apparatus for scoring a glass ribbon moving along a longitudinal axis of a channel which comprises a linear slide adapted for mounting across the channel at an angle relative to a transverse axis of the channel, a traveling carriage coupled to the linear slide for travel along the linear slide, and a light-emitting device coupled to the traveling carriage and operable to emit a light beam at a wavelength that is absorbable at a surface of the glass ribbon. In one example, the light-emitting device emits a laser beam. The apparatus may further include a linear motion drive coupled to the linear slide for moving the traveling carriage along the linear slide. The apparatus may further include a nozzle having an inlet end for communication with a fluid source, such as a coolant source, and arranged for travel in tandem with the light-emitting device. The apparatus may further include a mechanical scoring device for initiating a crack in the glass ribbon. The mechanical scoring device may be coupled to the linear slide and arranged for travel in tandem with the light-emitting device, wherein the mechanical scoring device precedes the light-emitting device and the nozzle trails the light-emitting device.

In another aspect, the invention relates to a system for scoring a moving glass ribbon which comprises a pair of guide members arranged in parallel and defining a channel having a longitudinal axis along which the glass ribbon moves, a linear slide mounted across the guide members and inclined at an angle relative to a transverse axis of the channel, a traveling carriage coupled to the linear slide for travel along a length of the linear slide, and a light-emitting device coupled to the traveling carriage and operable to emit a light beam at a wavelength that is absorbable at a surface of the glass ribbon. In one example, the speed of the glass ribbon, the inclination angle, and the speed of the traveling carriage are selected such that the light beam heats the glass ribbon along a line parallel to the transverse axis of the channel. The system may further include a device for initiating a crack in the glass ribbon along the line parallel to the transverse axis of the channel. In one example, the light-emitting device emits a laser beam. The system may further include a control system for adjusting the speed of the traveling carriage in response to a speed of the moving glass ribbon and/or the inclination angle of the linear slide. In one example, the linear slide is mounted across the channel such that the inclination angle of the linear slide relative to the transverse axis of the channel is adjustable. The system may further include a linear drive for moving the traveling carriage along the linear slide. The system may further include a nozzle having an inlet end for communication with a fluid source, such as a coolant source, and arranged for travel in tandem with the light-emitting device. The system may further include rollers or edge guides arranged along the guide members for receiving side edges of the glass ribbon and drawing the glass ribbon through the channel. The channel may include one or more temperature-controlled zones.

In yet another aspect, the invention relates to a method of scoring a glass ribbon which comprises conveying the glass ribbon along a longitudinal axis of a channel, moving a traveling carriage along a linear slide mounted across and inclined at an angle relative to a transverse axis of the channel, and operating the light-emitting device coupled to the traveling carriage to emit a light beam which heats the glass ribbon and thereby creates a score line across the glass ribbon. In one example, moving the traveling carriage includes selecting the speed of the moving glass ribbon, the speed of the traveling carriage, and the inclination angle of the linear slide such that the light beam heats the glass ribbon along a line parallel to the transverse axis of the channel. The method may further include applying a coolant to an area of the glass ribbon in which the light beam is absorbed to create a thermal shock in the area, thereby creating a score line in the area. In one example, the light-emitting device emits a laser beam.

Other features and advantages of the invention will be apparent from the following description and the appended claims.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1A depicts a scoring system for forming a score line across a width of a moving glass ribbon.

FIG. 1B depicts a side view of the scoring system of FIG. 1A.

FIG. 1C is a velocity diagram for the scoring system of FIG. 1A.

FIG. 1D depicts an end view of the scoring system of FIG. 1A.

FIG. 1E depicts coolant, light beam, and scoring wheel moving in tandem across a glass ribbon.

FIG. 2 shows the scoring system of FIG. 1A incorporated in a fusion draw process.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

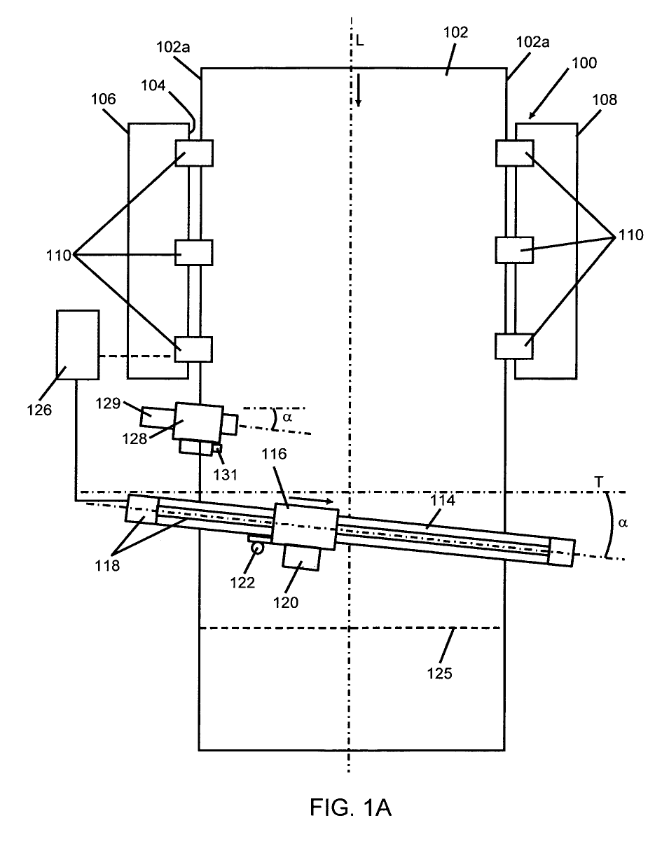

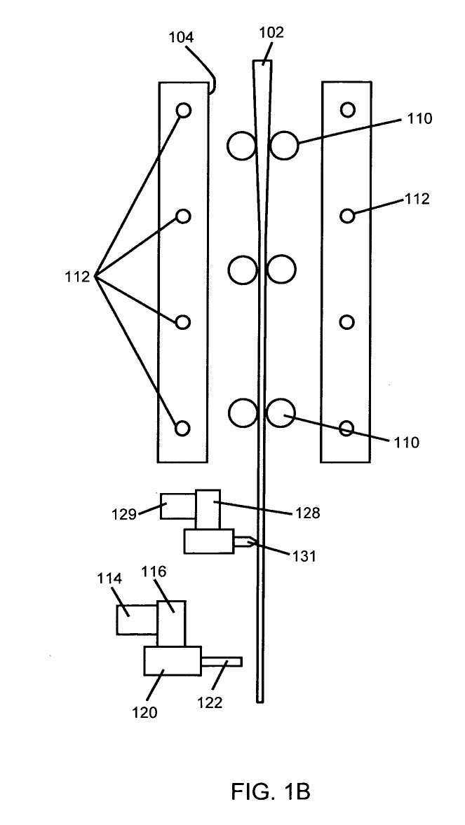

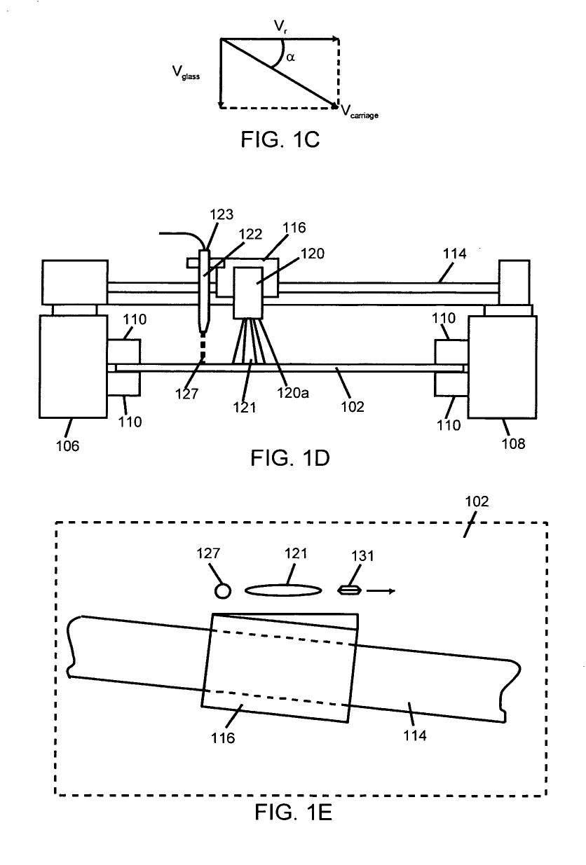

FIG. 1A depicts a scoring system 100 for scoring a moving glass ribbon 102. The glass ribbon 102 may have any desired cross-sectional shape, but is usually in the form of a plane or sheet. In the example depicted in FIG. 1A, the glass ribbon 102 moves along a longitudinal axis (L) of a channel 104 defined by a pair of elongated guide members 106, 108 arranged in parallel. The channel 104 may be vertical or may have other orientation, for example, horizontal or inclined. In the example depicted in FIG. 1A, paired rollers 110 are arranged along each of the guide members 106, 108. The paired rollers 110 grip the side edges 102a of the glass ribbon 102 while advancing the glass ribbon 102 through the channel 104, typically at a controlled speed. Spacing between the rollers of the paired rollers 110 may be constant or may progressively decrease along the length of the channel 104. The paired rollers 110 draw the glass ribbon 102 to a particular thickness by pulling the glass ribbon 102 at a faster speed than the glass ribbon 102 would otherwise advance through the channel 104. Other suitable edge guides besides paired rollers may be used to draw the glass ribbon 102 through the channel 104. As shown in FIG. 1B, heating elements 112 may be arranged along the channel 104 to define one or more temperature-controlled zones within the channel 104. For example, where the glass ribbon 102 enters the channel 104 in molten form, the temperature-controlled zones may be such that the glass ribbon 102 is allowed to cool down progressively in a controlled manner as it advances along the longitudinal axis of the channel 104.

Returning to FIG. 1A, the scoring system 100 includes a linear slide (or linear guide rail) 114 mounted across the channel 104. The linear slide 114 may be mounted across the channel 104 using any suitable method. For example, the linear slide 114 may be attached to support structures (not shown) generally parallel to the guide members 106, 108 using screws, clamp devices, or other suitable fasteners. The linear slide 114 is inclined at an angle (α) to a transverse axis (T) of the channel 104 or glass ribbon 102. The transverse axis (T) of the channel 104 is an axis perpendicular to the longitudinal axis (L) of the channel 104 or perpendicular to the direction in which the glass ribbon 102 moves within the channel 104. A traveling carriage 116 is mounted on the linear slide 114 and arranged for travel along the linear slide 114. The linear slide 114 may include a linear motion drive 118, such as a lead screw drive or belt drive, which may be used to automatically and controllably drive the traveling carriage 116 along the linear slide 114. In one example, the linear motion drive 118 allows bi-directional travel of the traveling carriage 116 along the linear slide 114. The angle of inclination of the linear slide 114 is such that the following relationship is satisfied:

$$sin α = \frac{{V}_{glass}}{{V}_{carriage}} \qquad ( 1 )$$

where α is the inclination angle of the linear slide relative to the transverse axis (T) of the channel 104, V_{glass} is the speed of at which the glass ribbon 102 moves through the channel 104, and V_{carriage} is the speed of the traveling carriage 116 along the linear slide 114. FIG. 1C illustrates the relationship in equation (1) graphically, where Vᵣ is the relative speed of the traveling carriage 116 to the glass ribbon 102.

Returning to FIG. 1A, the scoring system 100 includes a light-emitting device 120 coupled to the traveling carriage 116. In one example, light beam from the light-emitting device 120 can heat the glass ribbon 102 without distorting the glass ribbon 102. The light-emitting device 120 includes active component(s), such as a light source, and/or passive component(s), such as lenses and mirrors. Where the light-emitting device 120 includes only passive component(s), the active component(s) can be located separately, away from the traveling carriage 116, and the passive component(s) can receive light from the active component(s) and shape the light beam with the appropriate size and energy profile for delivery to the glass ribbon 120. In one example, the light-emitting device 120 emits a laser beam. The laser beam may be generated by lasers including, but not limited to, carbon dioxide laser and Nd:YAG laser. As more clearly shown in FIG. 1D, the light-emitting device 120 is coupled to the traveling carriage 116 such that its outlet end 120a is in opposing relation to the glass ribbon 102. The light-emitting device 120 emits a light beam 121, which may be a laser beam, that locally heats the glass ribbon 102 as the traveling carriage 116 moves along the linear slide 114. Returning to FIG. 1A, the light beam from the light-emitting device 120 heats the glass ribbon 102 along a line parallel to the transverse axis of the channel 104 if the relationship stated in equation (1) is satisfied, creating a horizontal score line, such as indicated at 125, across the glass ribbon 102. It should be noted that element 125 depicts a score line after the light-emitting device 120 has traversed the entire width of the glass ribbon 102. The orientation of the horizontal score line is parallel to the transverse axis of the channel 104. The wavelength of the light beam emitted by the light-emitting device 120 is selected such that the light beam can be absorbed at the surface of the glass ribbon 102. The light beam may have any desired shape, such as elliptical or circular. Preferably the size of the light beam is such that heating of the glass ribbon 102 is constrained to the vicinity of the desired score line.

FIG. 1D shows that the scoring system 100 may include a nozzle 122 having an inlet end 123 in communication with a fluid source (not shown). The nozzle 122 may be used to apply a coolant 127 to the heated area of the glass ribbon 102 as the score line is formed. The nozzle 122 may be coupled to the traveling carriage 116 so that it can travel in tandem with the light-emitting device 120. In one example, a crack is created in the glass ribbon 102 before the light-absorbed (heated) surface is cooled by the coolant 127 and thereby experiences thermal shock.

Returning to FIG. 1A, the scoring system 100 may include a mechanical scoring device, for example, a scoring wheel 131, for initiating a crack in the glass ribbon 102, typically prior to operating the light-emitting device 120. In one example, the scoring wheel 131 is mounted on a traveling carriage 128 on a linear slide 129, where the linear slide 129 is mounted parallel to the linear slide 114 carrying the light-emitting device 120. Alternatively, the scoring wheel 131 may be mounted on the linear slide 114. In this alternative example, the scoring wheel 131, the light-emitting device 120, and the nozzle 122 may be coupled to the traveling carriage 116 so that they travel in tandem. In this arrangement, as illustrated in FIG. 1E, the coolant 127 would trail the light beam (or laser beam) 121 while the scoring wheel 131 would precede the light beam (or laser beam) 121. Since the scoring wheel 131 is only relied on for creating an initial crack, it is not necessary that a reaction force is provided for the scoring wheel 131 as the traveling carriage 116 traverses the width of the glass ribbon 102. At the point of initiating a crack in the glass ribbon, a back support may be provided for the scoring wheel 131, for example, using a nose or roller. Typically, the point at which the crack is initiated in the glass ribbon 102 would be very small and would be outside of the quality area of the glass ribbon 102. Typically, the time for initiating the crack using the scoring wheel 131 would be fast, for example, on the order of a fraction of a second, to avoid a long initiation score length. The scoring wheel 131 may be retracted after making the initial crack.

Referring to FIGS. 1A-1E, when it is desired to score the glass ribbon 102, the traveling carriage 116 is positioned at one edge of the glass ribbon 102. Then, the traveling carriage 116 is actuated so that it travels along the linear slide 114 at a speed that allows the relationship in equation (1) above to be satisfied. While the traveling carriage 116 is moving along the linear slide 114, the light-emitting device 120 emits a laser beam that heats the glass ribbon 102 followed by a cooling nozzle, thereby creating a horizontal score line across the glass ribbon 102. An initial crack may be created at the starting edge of the glass ribbon 102 to serve as a starting point for the horizontal score line, whereby the laser beam and the cooling nozzle would then propagate the crack across the glass ribbon 102. The coolant when applied to the heated area creates a crack in the glass ribbon 102 due to thermal shock. A control system 126 which controls motion of the traveling carriage 116 can receive the speed of the glass ribbon 102 as input and adjust the speed of the traveling carriage 116 as necessary such that the relationship in equation (1) is satisfied during scoring. The control system 126 may include a processor, input/output devices, and logic for controlling speed of the traveling carriage 116 in response to the speed of the glass ribbon 102 and/or inclination angle of the linear slide 114. The speed of the glass ribbon 102 can be obtained from the speed of the rollers 110. Alternatively, a sensor device (not shown) may be used to monitor the speed of the glass ribbon 102.

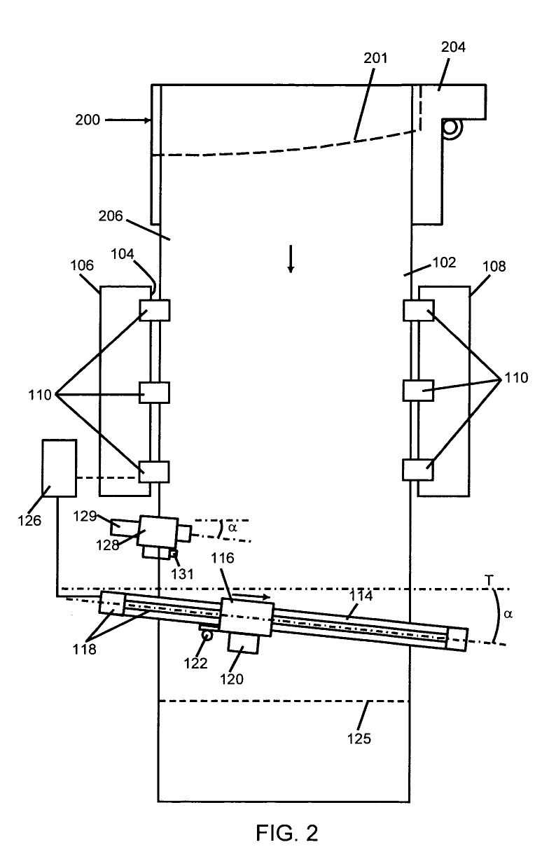

In one example, the scoring system 100 described above is used in a fusion draw process. As illustrated in FIG. 2, molten glass 200 flows into a channel 201 of a fusion pipe 204 and overflows from the channel and down the sides of the fusion pipe 204 in a controlled manner to form a sheet-like flow 206. The outer surfaces of the sheet-like flow 206 do not come into contact with any solid material and are therefore pristine and of fire-polished quality. The sheet-like flow 206 forms the glass ribbon 102 that is received in the channel 104. The channel 104 includes one or more controlled heated zones as previously described to gradually cool down the glass ribbon 102. The paired rollers 110 control the thickness and flatness of the glass ribbon 102 without touching the quality area of the glass ribbon 102. The glass ribbon 102 can be scored at the end of the channel 104 as described above. A conventional bending technique can then be used to sever the glass ribbon 102 along the score line to create a piece of glass that can be easily handled. For example, a robot with suction cups can grab the glass ribbon 102 below the score line and bend the glass ribbon 102 such that the glass ribbon 102 separates at the score line. The piece of glass severed from the glass ribbon can be subjected to finishing processes and packaged for use. After a horizontal score line is made as described above, the traveling carriage 116 returns to the starting position in preparation for making another horizontal score line. Actuation of the traveling carriage 116 can be timed such that the glass ribbon 102 is scored at regular intervals.

Returning to FIG. 1A, in the scoring system 100, the speed of the glass ribbon 102 can be selected independent of the speed of the traveling carriage 116 as long as the relationship stated in equation (1) is satisfied. For a selected speed of the glass ribbon 102, the speed of the traveling carriage 116 can be determined based on the inclination angle of the linear slide 114 with respect to the transverse axis of the channel 104 or glass ribbon 102. It is also possible to support the linear slide 114 relative to the channel 104 such that the inclination angle of the linear slide 114 with respect to the transverse axis of the channel 104 or glass ribbon 102 is adjustable. For example, the linear slide 114 may be coupled at one end to a support structure (not shown) generally parallel to the guide member 106 via a pivot connection and at the other end to a support structure (not shown) generally parallel to the guide member 108 via a slidable connection, where the slidable connection can be actuated to change the inclination angle of the linear slide 114. The speed of the traveling carriage 116 and the inclination angle of the linear slide 114 can be controlled such that the relationship stated in (1) is satisfied as the score line is made. The scoring system 100 can enable relatively faster cycle times because it does not require the traveling carriage 116 to travel with the glass ribbon 102 at the same speed which require another axis of displacement and results in longer time to complete its cycle. The scoring system 100 also avoids hard contact with the quality area of the glass ribbon 102 during scoring, thereby preventing surface damage in the quality area of the glass ribbon 102.

The invention has been described with respect to a limited number of embodiments. However, those skilled in the art, having benefit of this disclosure, will appreciate that other embodiments can be devised which do not depart from the scope of the invention as disclosed herein. Accordingly, the scope of the invention should be limited only by the attached claims.

1. A method of scoring a glass ribbon, comprising:
conveying the glass ribbon along a longitudinal axis of a channel;
moving a traveling carriage along a linear slide mounted across and inclined at an angle relative to a transverse axis of the channel; and
operating the light-emitting device coupled to the traveling carriage to emit a light beam at a wavelength that is absorbed at the surface of the glass ribbon.

2. The method of claim 1, wherein moving the traveling carriage comprises selecting the speed of the moving glass ribbon, the speed of the traveling carriage, and the inclination angle of the linear slide such that the light beam heats the glass ribbon along a line parallel to the transverse axis of the channel.

3. The method of claim 2, wherein operating the light-emitting device comprises applying a coolant to an area of the glass ribbon in which the light beam is absorbed to create a thermal shock in the area, thereby creating a score line in the area.

4. The method of claim 3, wherein the light-emitting device emits a laser beam.

5. An apparatus for scoring a glass ribbon moving along a longitudinal axis of a channel, comprising:
a linear slide adapted for mounting across the channel at an angle relative to a transverse axis of the channel;
a traveling carriage coupled to the linear slide for travel along the linear slide; and
a light-emitting device coupled to the traveling carriage and operable to emit a light beam at a wavelength that is absorbable at a surface of the glass ribbon.

6. The apparatus of claim 5, wherein the light-emitting device emits a laser beam.

7. The apparatus of claim 5, further comprising a linear motion drive coupled to the linear slide for moving the traveling carriage along the linear slide.

8. The apparatus of claim 5, further comprising a nozzle having an inlet end for communication with a fluid source and arranged for travel in tandem with the light-emitting device.

9. The apparatus of claim 8, further comprising a mechanical scoring device for initiating a crack in the glass ribbon.

10. The apparatus of claim 9, wherein the mechanical scoring device is coupled to the linear slide and arranged for travel in tandem with the light-emitting device, wherein the mechanical scoring device precedes the light-emitting device and the nozzle trails the light-emitting device.

11. A system for scoring a moving glass ribbon, comprising:
a pair of guide members arranged in parallel and defining a channel having a longitudinal axis along which the glass ribbon moves;
a linear slide mounted across the guide members and inclined at an angle relative to a transverse axis of the channel;
a traveling carriage coupled to the linear slide for travel along a length of the linear slide; and
a light-emitting device coupled to the traveling carriage and operable to emit a light beam at a wavelength that is absorbable at a surface of the glass ribbon.

12. The system of claim 11, wherein the speed of the glass ribbon, the inclination angle, and the speed of the traveling carriage are selected such that the light beam heats the glass ribbon along a line parallel to the transverse axis of the channel.

13. The system of claim 12, further comprising a device for initiating a crack in the glass ribbon along the line parallel to the transverse axis of the channel.

14. The system of claim 11, wherein the light-emitting device emits a laser beam.

15. The system of claim 11, further comprising a control system for adjusting the speed of the traveling carriage in response to a speed of the moving glass ribbon and/or the inclination angle of the linear slide.

16. The system of claim 11, wherein the linear slide is mounted across the channel such that the inclination angle of the linear slide relative to the transverse axis of the channel is adjustable.

17. The system of claim 11, further comprising a linear motion drive for moving the traveling carriage along the linear slide.

18. The system of claim 11, further comprising a nozzle having an inlet end for communication with a fluid source and arranged for travel in tandem with the light-emitting device.

19. The system of claim 11, further comprising rollers arranged along the guide members for receiving side edges of the glass ribbon and drawing the glass ribbon through the channel.

20. The system of claim 11, wherein the channel comprises one or more temperature-controlled zones.
